(19) United States
(12) Patent Application Publication
(10) Pub. No.: US 2009/0210302 A1
(43) Pub. Date: Aug. 20, 2009

(54) ROUTE REWARD AUGMENTATION

(75) Inventors: Ivan J. Tashev, Kirkland, WA (US); Jeffrey D. Couckuyt, Bothell, WA (US); John C. Krumm, Redmond, WA (US); Ruston Panabaker, Redmond, WA (US); Michael Lewis Seltzer, Seattle, WA (US); Neil W. Black, Seattle, WA (US)

Correspondence Address: TUROCY & WATSON, LLP, 127 Public Square, 57th Floor, Key Tower, CLEVELAND, OH, 44114, US

(73) Assignee: MICROSOFT CORPORATION, Redmond, WA (US)

(21) Appl. No.: 12/033,652

(22) Filed: Feb. 19, 2008

(51) Int. Cl. G06Q 30/00; G01C 21/00

(52) U.S. Cl. 705/14; 701/202

(57) ABSTRACT

Different incentives can be provided to a user for the user to take different routes. Information related to a user's specific situation can be gathered and a reward can be associated with a route. A user can input an intended destination and different routes can be taken, where the routes have various characteristics. The route can be analyzed and a determination can be made as to what routes can be associated with a user taking a particular route. Commonly, different companies can supply rewards such that the user travels past their advertisement or makes a stop at their store.

### TECHNICAL FIELD

The subject specification relates generally to traffic routing and in particular to rewarding a user for taking a specific route.

### BACKGROUND

Computer-driven route planning applications are utilized to aid users in locating points of interest, such as particular buildings, addresses, and the like. Additionally, in several existent commercial applications, users can vary a zoom level, thereby enabling variation of context and detail as a zoom level of a map is altered. For example, as a user zooms in on a particular location, details such as names of local roads, identification and location of police and fire stations, identification and location of public services, such as libraries, museums, and the like can be provided to the user. When zooming out, the user can glean information from the map such as location of the point of interest within a municipality, state/providence, and/or country, proximity of the point of interest to major freeways, proximity of the point of interest to a specific city, and the like.

Furthermore, conventional computer-implemented mapping applications often include route-planning applications that can be utilized to provide users with directions between different locations. Pursuant to an example, a user can provide a route planning application with a beginning point of travel and an end point of travel (e.g., beginning and ending addresses). The route planning application can include or utilize representations of roads and intersections and one or more algorithms to output a suggested route of travel. These algorithms can output routes depending upon user-selected parameters. For instance, a commercial route planning application can include a check box that enables a user to specify that she desires to avoid highways. Similarly, a user can inform the route planning application that she wishes to travel on a shortest route or a route that takes a least amount of time (as determined by underlying algorithms). Over the last several years, individuals have grown to rely increasingly on route planning applications to aid them in everything from locating a friend's house to planning cross-country road trips.

### SUMMARY

The following discloses a simplified summary of the specification in order to provide a basic understanding of some aspects of the specification. This summary is not an extensive overview of the specification. It is intended to neither identify key or critical elements of the specification nor delineate the scope of the specification. Its sole purpose is to disclose some concepts of the specification in a simplified form as a prelude to the more detailed description that is disclosed later.

With the disclosed innovation, a user can be provided specific incentive to travel along a certain route or to perform an action along the route. The route can be analyzed against user history and a reward can be determined that is likely to convince a user to take the route/action. An obtainment component collects various amounts of information, ranging from available paths to situational characteristics of the user. A reward can be determined, associated with the route, and presented to the user. Deeds of the user can be monitored to determine if she followed set criterion and thus is entitled to the reward. Commonly, the reward can be intertwined with advertising, such that if a user drives a long a route and passes an advertisement, she will be rewarded (e.g., a coupon discount for an advertised establishment).

Initially, route information, reward data, contextual detail, and the like can be collected from various sources. The collected materials are analyzed in view of possible rewards that can be associated with taking certain routes. A reward and a route are selected and associated together based upon a result of the analysis, such that if the user takes the route, then she receives the reward. The user can be informed of the route and reward—actions of the user are monitored to determine if the route is being followed. If the user follows the route, then the reward is assigned to the user and a notification can be provided that reward criterion is successfully completed.

The following description and the annexed drawings set forth certain illustrative aspects of the specification. These aspects are indicative, however, of but a few of the various ways in which the principles of the specification can be employed. Other advantages and novel features of the specification will become apparent from the following detailed description of the specification when considered in conjunction with the drawings.

### BRIEF DESCRIPTION OF THE DRAWINGS

FIG. 1 illustrates a representative system for association of a reward with a route in accordance with an aspect of the subject specification.

FIG. 2 illustrates a representative system for association of a reward with a route with a detailed obtainment component in accordance with an aspect of the subject specification.

FIG. 3 illustrates a representative system for association of a reward with a route with a detailed association component in accordance with an aspect of the subject specification.

FIG. 4 illustrates a representative system for association of a reward with a route with a transaction component and disclosure component in accordance with an aspect of the subject specification.

FIG. 5 illustrates a representative system for association of a reward with a route able to generate the route as well as monitor actions in accordance with an aspect of the subject specification.

FIG. 6 illustrates a representative reward correlation methodology in accordance with an aspect of the subject specification.

FIG. 7 illustrates a representative monitoring methodology in accordance with an aspect of the subject specification.

FIG. 8 illustrates a representative reward association methodology in accordance with an aspect of the subject specification.

FIG. 9 illustrates an example of a schematic block diagram of a computing environment in accordance with an aspect subject specification.

FIG. 10 illustrates an example of a block diagram of a computer operable to execute the disclosed architecture.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It can be evident, however, that the claimed subject matter can be practiced without these specific details. In other instances, well-known structures and devices are shown in block diagram form in order to facilitate describing the claimed subject matter.

As used in this application, the terms “component,” “module,” “system,” “interface,” or the like are generally intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. As another example, an interface can include I/O components as well as associated processor, application, and/or API components.

As used herein, the terms to “infer” or “inference” refer generally to the process of reasoning about or deducing states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Furthermore, the claimed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. It is to be appreciated that determinations or inferences referenced throughout the subject specification can be practiced through use of artificial intelligence techniques.

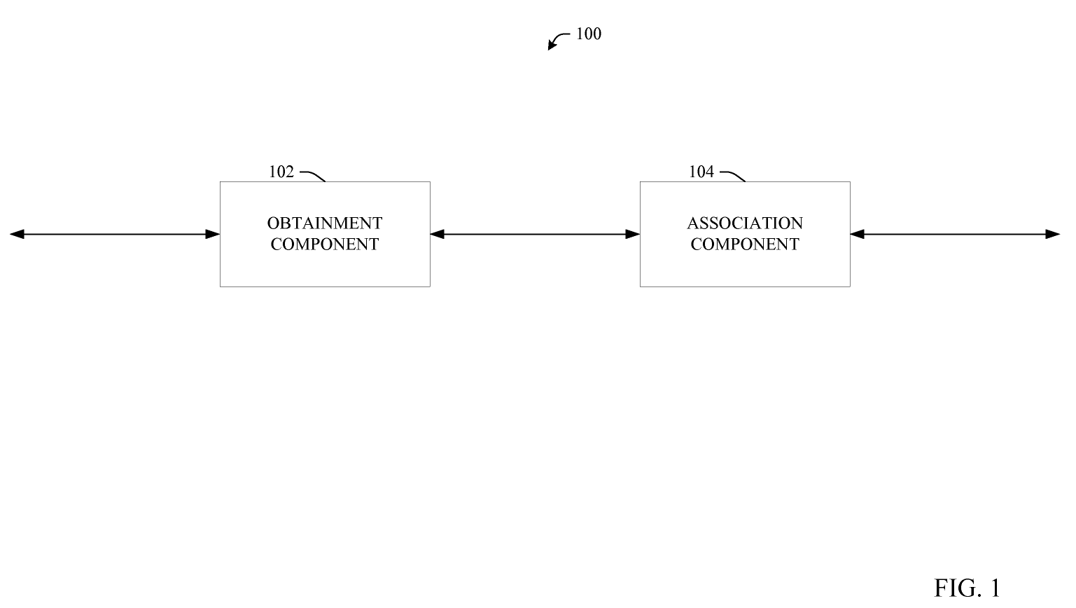

Now referring to FIG. 1, an example system 100 is disclosed for associating a reward with a route such that if a user performs an action upon the route, then she is entitled to the reward. Conventionally, a user travels along a route in a vehicle and does not take action upon the route or takes an action arbitrarily. The disclosed innovation allows a user to be rewarded for taking a route and/or taking an action along a route, thus providing motivation for the user.

An obtainment component 102 can collects route information (e.g., a direction set a user is scheduled to take), reward data (e.g., information of a company offering a reward to the user for stopping at a store along the direction set), contextual detail (e.g., user personal history), or a combination thereof. A route can be generated according to input information, such as a user location and desired destination, and transferred to the obtainment component 102. The obtainment component 102 can analyze the route and determine locations the user is anticipated to pass. User history can be surveyed to determine locations that have a particular likelihood of being of interest to the user. The determined locations can be solicited for rewards and businesses associated with the locations can supply offers.

The collected material can transfer to an association component 104 that can link a reward to a route based upon at least a portion of the collection of the obtainment component 102. According to one embodiment, all received reward offers can be linked with the route. However, since it is possible that there are a large number of rewards that can ultimately confuse a user, selection can take place that limits rewards that are linked. For example, rewards can be selected based upon interest to the user (e.g., a reward tied with a location that has a high likelihood of being interesting to a user), monetary amount (e.g., a reward that has a highest value), and the like.

Moreover, the user can be engaged to the system 100 and supply input (e.g., collected by the obtainment component 102) such that the user specifies characteristics of system 100 operation. For instance, the user can make a request that one reward be linked with a route for a specific purpose. The user can desire to stop for lunch and request that a reward be tied to an eating establishment. Different inferences can be made, such as if a user is a vegetarian, then it can be inferred establishments specializing in hamburger are to be avoided. Based upon the inferences, the association component 104 can link a particular reward associated with a restaurant with the route. Oftentimes, a route produced to a user from the system 100 can be an alteration from a standard route—the altered route and standard route are commonly different where the standard route is altered such that the user travels to a location that allows her to earn an incentive.

Rewards can be associated with a route such that a user is provided an incentive for taking a route. For instance, a user can be provided a monetary amount for taking a route that is high in fuel-efficiency, taking a route that assists in traffic load balancing, and the like. Other types of rewards can be offered to a user for using a route designed to alleviate traffic load balancing congestion, such as a discounted toll on a road or not requiring the user to pay the toll.

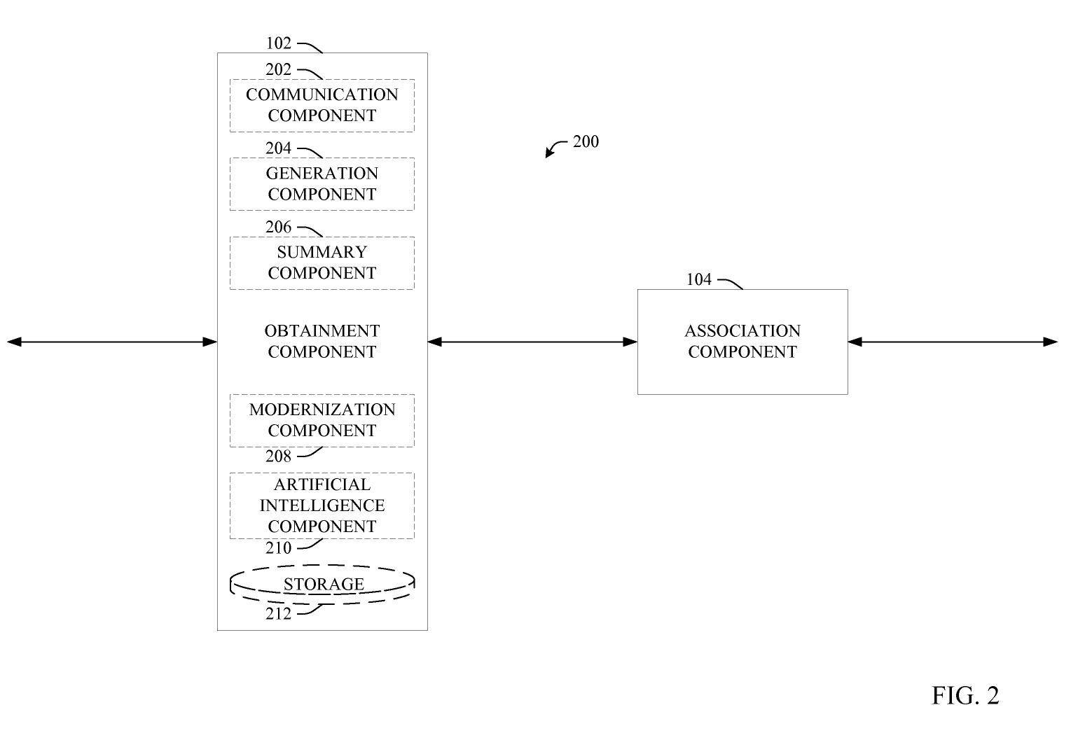

Now referring to FIG. 2, an example system 200 is disclosed for associating a reward with a route highlighting an example detailed obtainment component 102. The obtainment component 102 can collect route information, reward data, contextual detail, or a combination thereof. A communication component 202 can engage with other devices to transfer information, such as to send a request for information, receiving information from an auxiliary source, etc. Operation can take place wirelessly, in a hard-wired manner, employment of security technology (e.g., encryption), etc. Information transfer can be active (e.g., query/response) or passive (e.g., monitoring of public communication signals). Moreover, the communication component 202 can utilize various protective features, such as performing a virus scan on collected data and blocking information that is positive for a virus.

A route can be created through a generation component 204, oftentimes based upon constraints provided by a user (e.g., a route to an intended destination, a route with minimal traffic, and the like). The generation component 204 can access a mapping database and determine paths that should be combined to create a direction set. Various features can integrate with the generation component 204 to enhance functionality. The generation component 204 can predict an intended destination of a user (e.g., through practice of artificial intelligence techniques) and create a route to the predicted intended destination. According to one embodiment, the generation component 204 produces multiple routes that enable a user to achieve an incentive. The user can select a route or a route can be determined for the user through an automated configuration.

A summary component 206 can maintain a profile of a user, where profile information is often collected by the obtainment component 102. Example of information of the profile can include personal preferences, statistical data of rewards that motivated the user to perform in a certain manner, user schedule (e.g., a user wants a reward, but does not want to be late for an appointment) and the like. According to one embodiment, the summary component 206 creates the profile and retains the profile in memory.

In addition, a modernization component 208 can update the profile of the user retained by the summary component 206. As changes occur, the maintained profile can be altered to become consistent with the changes. For example, if a user was once enamored with a particular store, but that store has now fallen out of favor with the user (e.g., learned through determinations based upon observed characteristics), then the modernization component 208 can change the profile to become more representative. Explicit preferences can also be taken into account by the modernization component 208—if a user continuously rejects rewards to a particular coffee shop, then reward offers to the coffee shop can be stopped (e.g., after a specific number if rejections). In addition, the modernization component 208 can add new data to the profile as the data becomes available.

An artificial intelligence component 210 can perform at least one inference or at least one determination that concerns collection of information, collection of data, collection of a detail, reward linkage, or a combination thereof. For instance, the artificial intelligence component 210 can infer an intended destination of the user based upon the profile, where the generation component 204 uses the inferred destination in production of a route. In addition, the artificial intelligence component 210 can determine if information from a source is reliable and if the information should be used in reward linkage.

The artificial intelligence component 210 can employ one of numerous methodologies for learning from data and then drawing inferences and/or making determinations related to applying a service (e.g., Hidden Markov Models (HMMs) and related prototypical dependency models, more general probabilistic graphical models, such as Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches that perform data fusion, etc.) in accordance with implementing various automated aspects described herein. Methods also include methods for the capture of logical relationships such as theorem provers or more heuristic rule-based expert systems.

Different pieces of information, such as collected materials, component operating instructions (e.g., of the generation component 204), source location, the profile maintained by the summary component 206, etc. can be held on storage 212. Storage 212 can arrange in a number of different configurations, including as random access memory, battery-backed memory, hard disk, magnetic tape, etc. Various features can be implemented upon storage 212, such as compression and automatic back up (e.g., use of a Redundant Array of Independent Drives configuration). An association component 104 can link a reward to a route based upon at least a portion of the collection of the obtainment component 102. To earn the reward the user can complete the route, performs an action upon the route, as well as other configurations.

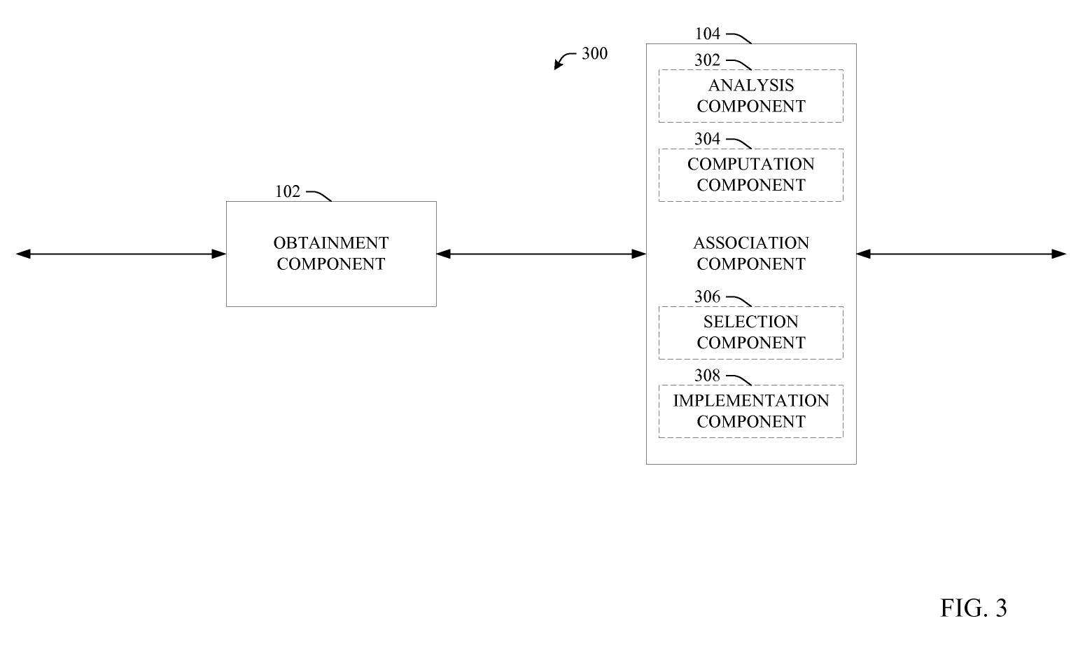

Now referring to FIG. 3, an example system 300 is disclosed for associating a reward with a route highlighting an example detailed association component 104. An obtainment component 102 can collect route information, reward data, contextual detail, or a combination thereof At least a portion of the collected material can transfer to an association component 104 that links a reward to a route based upon at least a portion of the collection of the obtainment component 102.

An analysis component 302 can evaluate material collected by the obtainment component 102; a result of the evaluation can be used to choose the reward for linkage upon the route. The obtainment component 102 can solicit advertisers to provide a reward for a user to take a route or to take an action upon a route. Responses can be collected and evaluated by the analysis component 302 to determine characteristics of a potential reward.

A computation component 304 can perform calculations in relation to determining a reward to link with a route and calculation results can be used in reward selection. Calculations can be relatively simple, such as determining a reward that is offering a highest value. However, calculations that are more complex can be performed, such as predicting likelihood of a user taking an action based upon a reward.

A selection component 306 can choose a reward for linkage upon the route. According to one embodiment, the selection component 306 uses results of the analysis to select the reward, such as a result of where a user likes to obtain fuel. The choice can be made to convince a user to act in a different manner (e.g., try a new restaurant located upon the route) or to encourage consistent user behavior (e.g., a coupon to the user's favorite restaurant located upon the route to discourage her from trying a new establishment). Ultimately, the summary component 206 of FIG. 2 can maintain a profile of a user, where profile information is collected by the obtainment component 102, evaluated by the analysis component 302, and used to choose a reward.

An implementation component 308 can implement actions consistent with linking the reward to the route. For instance, computer code can be written by the implementation component 308 such that the reward and route connect. However, other configurations can be practiced, such as notifying an unit that observes driver operations that a reward is to be associated with an action and a signal should be sent when/if the driver performs the action.

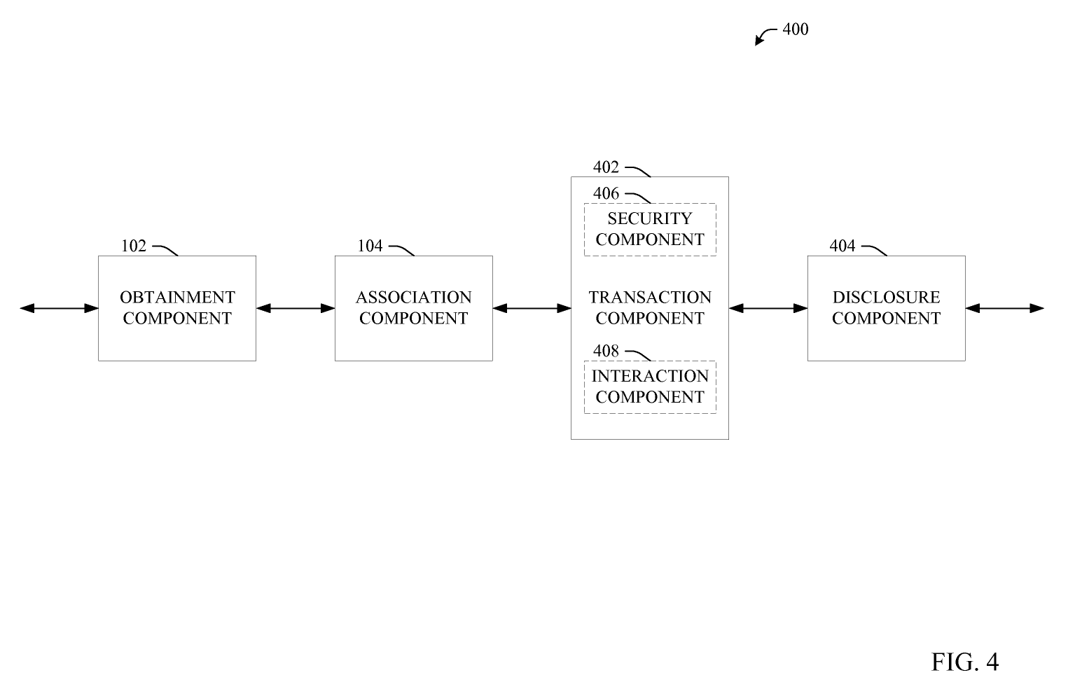

Now referring to FIG. 4, an example system 400 is disclosed for associating a reward with a route highlighting an example transaction component 402 and example disclosure component 404. An obtainment component 102 can collect route information, reward data, contextual detail, or a combination thereof. The collected information can be utilized by an association component 104 that links a reward to a route based upon at least a portion of the collection of the obtainment component 102.

A transaction component 402 can perform a financial operation that relates to collection of information, collection of data, collection of a detail, reward linkage, or a combination thereof. The transaction component 402 can perform actions to meet constraints, such as debiting a user account and crediting a provider account. While fiscal amounts are commonly transacted, it is to be appreciated that other commodities can be exchanged, such as coupons, meeting of contractual obligations (e.g., canceling of a task to be performed), tax credits, etc.

The financial operation can include transfer of the linked reward based upon a user following at least a part of the route, the user following about the entire route, the user taking a designated action upon the route, or a combination thereof. Moreover, a reward function can take place in relation to user response to a commercial detail. For example, an advertisement can be played that a user should stop at a highway exit for a cup of coffee. If the user takes the exit, buys the cup of coffee, buys a different item, etc., then payments of varying amounts can be made to an advertisement hosting service.

A security component 406 can regulate operation of the transaction component 402. Oftentimes, the transaction component 402 can transfer a reward from a banking account of a company to an account of a user. Since this can be considered sensitive information, the security component 406 can protect this transfer through implementation of encryption, password protection, and the like. Moreover, the security component 406 can check fiscal operations for consistency and perform correction operations. If a wrong amount of money is sent from one party, then the security component 406 can identify an error and send notice that a different amount should be sent.

An interaction component 408 can enable a user to input information to the system 400. Commonly, the interaction component 408 can implement as a touch screen of the disclosure component 404, a keyboard, loudspeaker and microphone, and the like. While shown as part of the transaction component 402 (e.g., used to enter a pin number), the interaction component 408 can implement as part of the obtainment component 102 to collect other information types (e.g., an intended destination).

A disclosure component 404 can provide the route to a user (e.g., operating a vehicle passenger or operator, as a pedestrian, etc.). A non-exhaustive list of disclosure components include a display screen, touch screen, speaker system, virtual reality environment, Braille production system, printer, etc. In addition, the disclosure component 404 can present information in multiple formats, such as showing a video with audio capabilities. Moreover, the disclosure component 404, as well as other components disclosed in the subject specification can implement upon a personal electronic device (e.g., cellular telephone, personal digital assistant, etc.), upon a vehicle (e.g., automobile, motorcycle, bicycle, airplane, helicopter, motorboat, self-balancing transportation device, etc.), etc. According to one embodiment, the association component 104 links at least two rewards to a route based upon at least a portion of the collection of the obtainment component 102, a first reward is linked to a first user and a subsequent reward is linked to a subsequent user. For instance, a reward can be provide to a driver by an advertisement placed on a left side of a road while a different reward is provided for a passenger viewing an advertisement on a right side of the road.

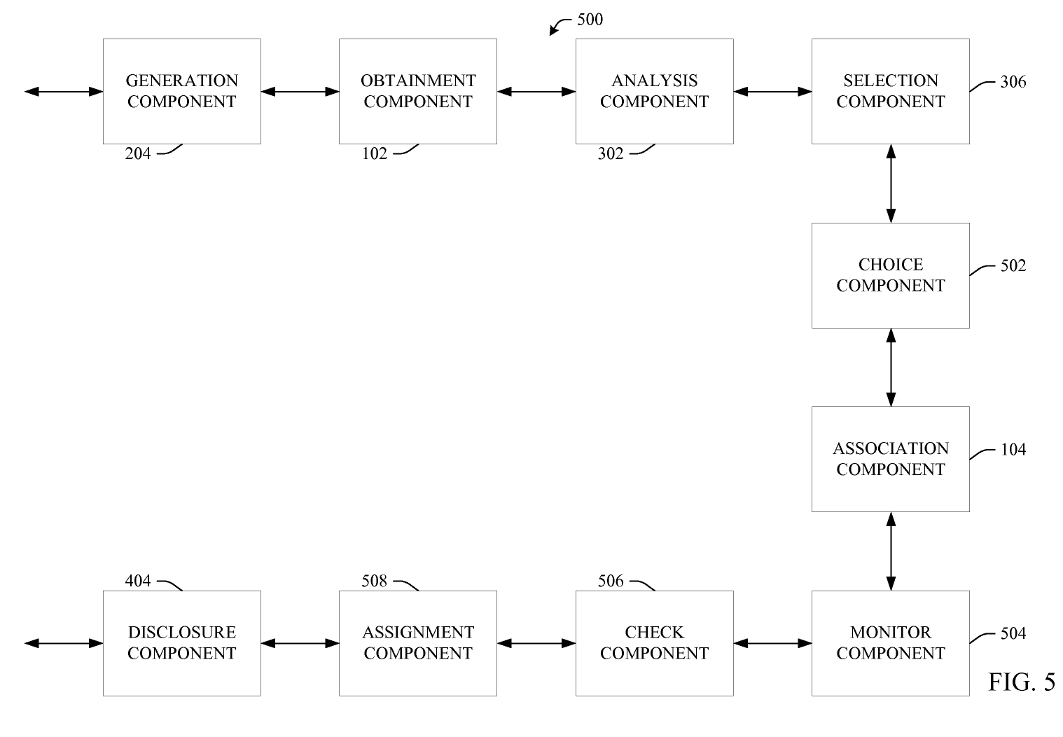

Now referring to FIG. 5, a system 500 is disclosed for implementing a reward upon a route. A generation component 204 can produce a route, commonly though constructing a new route or altering an existing route. The user can be asked to approve the route prior to utilizing the route in the system 500. If the user does not approve, then a new route can be produced. The generation component 204 can implement as a means for generating the route.

An obtainment component 102 can collect a plethora of information related to a user, a vehicle implementing the system 500, a route produced by the generation component 204, and the like. The obtainment component 102 can function as a means for collecting route information, reward data, contextual detail, or a combination thereof. In addition to collecting information, the obtainment component 102 can filter information in an effort to conserve resources of other units.

An analysis component 302 can evaluate materials gathered by the obtainment component 102, oftentimes material filtered through the obtainment component 102. A results package can be produced though the evaluation that includes various statistical information (e.g., advertisement bids, user history, etc.). The analysis component 302 can operate as a means for analyzing at least a portion of the collected material. The analysis component 302 can determine a route that is for linkage with a reward as well as evaluate the route.

A selection component 306 can determine a reward that is appropriate for a user. According to one embodiment, the selection component 306 balances an estimate of a reward that a user will desire to change action against a reward provider interest of spending a low amount of money. The selection component 306 can operate as a means for selecting a reward, the selection is based upon a result of the analysis.

A choice component 502 can determine what a user is to do in order to earn a reward. This can be set forth by a requesting party providing a reward, inferred by previous engagements with a requesting party, determined by observing user action, and the like. The choice component 502 can function as a means for choosing at least one action for a user to follow upon a route in order to gain a reward, the choice is based upon a result of the analysis.

An association component 104 can link the reward selected by the selection component 306 with the route produced by the generation component 204. The association component 104 can ask a user to approve of a reward linkage prior to operation. The association component 104 can operate as a means for linking the selected reward with the route.

A monitor component 504 can observe actions of the user and create information related to the observation. In typical operation, the observation is concerning if the user is following at least one criterion to earn the reward set forth by the choice component 502. The monitor component 504 can implement as a means for monitoring the user.

A check component 506 can concludes if a user has performed in a manner consistent with earning the reward, transfer of the linked reward occurs upon a positive conclusion (e.g., a user passes a location, a user make a purchase, etc.). According to one embodiment, exact criteria is met—however, it is possible for other implementations, such as a substantial amount of criteria to be met (e.g., travel 95% along a route, pass by certain advertisements along a route, and the like). The check component 506 can operate as a means for determining if the user followed the chosen action based upon a result of the monitoring.

If the check component 506 determines that a user has met an appropriate standard to earn a reward, then an assignment component 508 can take action to supply the reward. For example, if the reward is a coupon, then the assignment component 508 can send a signal to a disclosure component 404 operating as a printer to print the coupon. The assignment component 508 can implement as a means for assigning the reward to the user.

The disclosure component 404 can communicate reward information to the user, including what the reward is, what the user is required to perform to earn the reward, and the like. The disclosure component 404 can present data to the user as well as to other entities, such as sending a message to a user's personal electronic device (e.g., cellular telephone, electronic mail account, and the like). The disclosure component 404 can function as a means for disclosing the route to the user.

According to one embodiment, the system 500 can operate dynamically, where different amounts of information change parameters of the reward. For example, a user can be offered an about $1 reward for stopping at a gasoline station of a company along a route, where there are two stations on the route. The monitor component 504 can observe a driver passed a first station and the analysis component 302 can infer that the user does not intend to stop at the station. The selection component 306 can determine that the reward should be increased to about $2 to motivate the driver to stop at the second station.

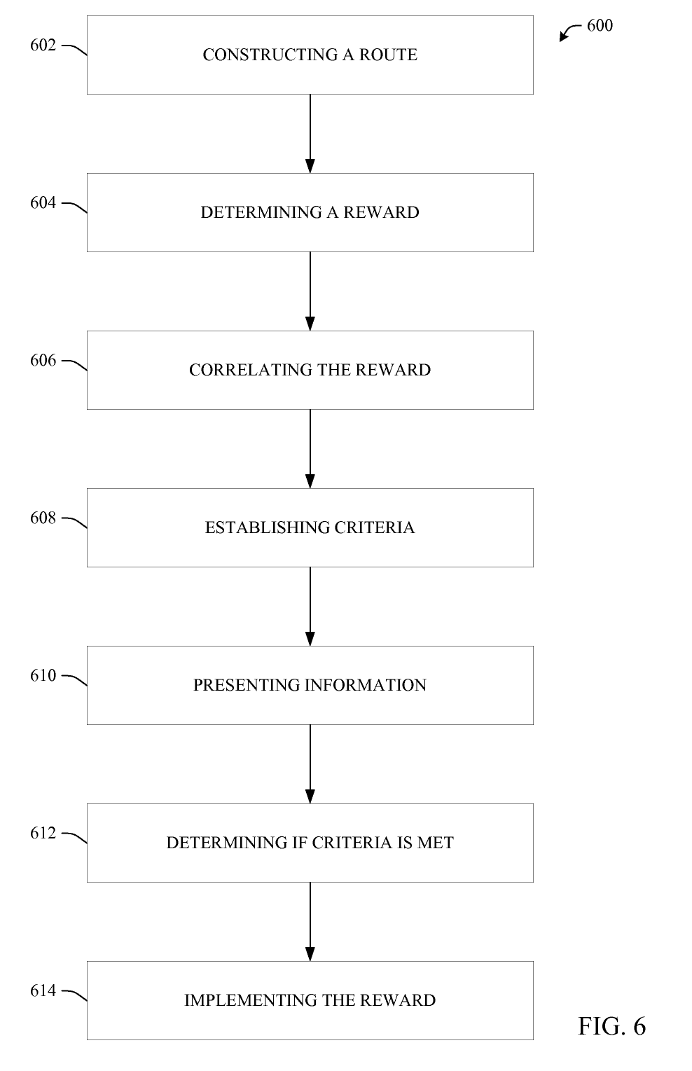

Now referring to FIG. 6, an example methodology 600 is disclosed for linking a reward with a route and determining at least one criterion for a user to earn the reward. A route can be constructed at event 602, commonly based upon a map database and user input. A user can input an intended destination and a current position can be determined through a global positioning system. A map database is analyzed and a route is created using common routing algorithms.

A reward that can be specific for a user is determined at action 604. Different rewards can be used to motivate a user to act in a certain manner. For instance, if the user is late to an appointment, then a higher reward or different kind of reward can be selected since it is relatively unlikely the user has a desire to make an additional stop along a route. Various calculations can take place, such as performing statistical analysis on previous behavior.

The reward is correlated with the route at event 606. Commonly, an assignment is made representing that a user can earn a reward by following at least one criterion though production of computer code. While methodologies disclosed in the subject specification discuss a user meeting criteria, it is to be appreciated that a single criterion can be used.

Criteria for the user to earn the reward are established at act 608. This can include establishing at least one criterion that a user follows to earn the reward, where the criterion includes at least one action taken upon the route. Example actions can be traveling along a route, making a stop on a route, making a purchase at a store located along a route, traveling below a maximum speed along a route, and the like.

At block 610, the reward and/or route information is presented to the user. According to one embodiment, a user is presented with the route and verbally a reward is announced to the user in conjunction with the established criteria. Approval of the user can be requested and the reward can be withheld if the user does not accept a reward offer.

A determination can be made at action 612 on if a user has met the established criteria. For instance, criteria can include that the user is to travel along a particular road below a maximum speed. A global positioning system can determine if the user stayed on the route and a sensor can be used to monitor how fast a user travels along the route. According to one embodiment, the user can be given a warning that she is close/has broken criteria and be given a chance to make a correction. For instance, if the maximum speed is about 30 miles per hour and a user reaches about 31 miles per hour, a warning can be presented and a user can be given a chance to go below the maximum speed within about five seconds and the reward can still be gained.

If the user has met the criteria, then the reward can be implemented at action 614. This can include transferring money between different accounts, such as a company offering a reward and crediting an account of the user. However, this can be less complicated, such as printing a coupon or sending a notice to a bank to make a particular transaction.

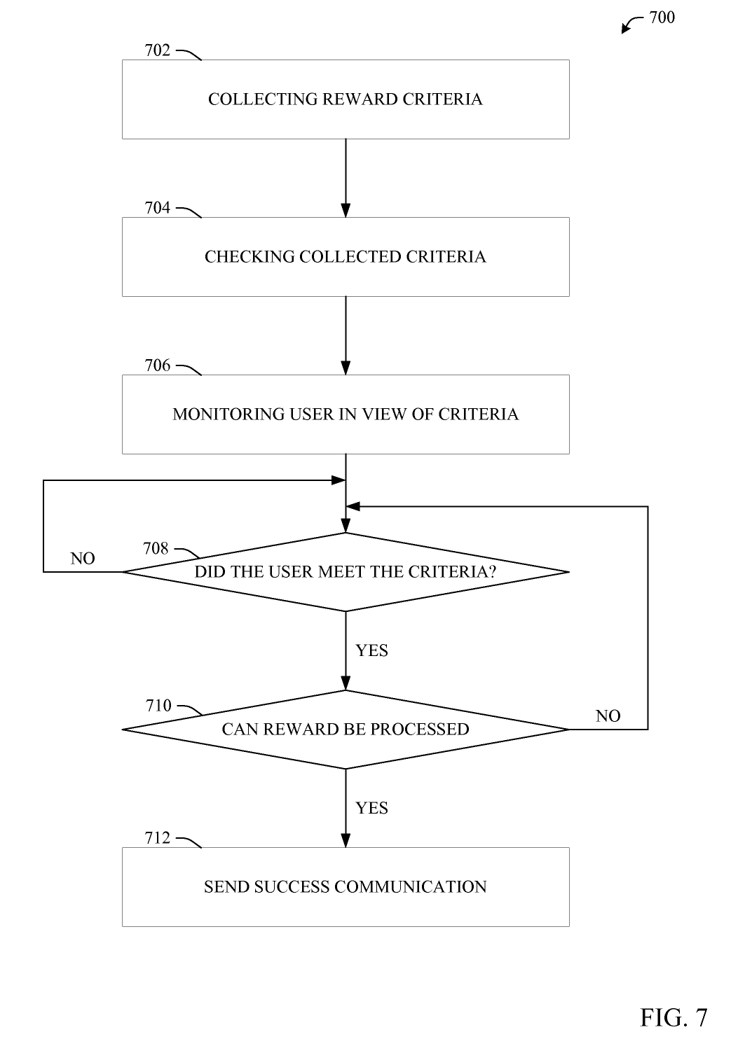

Now referring to FIG. 7, an example methodology 700 is disclosed for determining if a user has performed in a matter consistent with earning a reward. Reward criteria can be collected at action 702, such as criteria established at act 608 of FIG. 6. This can be done in a wireless manner, through extracting data from local or removable storage, and the like.

The collected criteria can be checked at event 704. It is possible that a request is received that a user stops at a store along a route. However, if there is construction and the store cannot be reached from the route, then a determination is made that the criteria is likely not to be met. A message can be sent to a requesting part and different reward/criteria can be selected.

A user can be monitored with regard to if the user has met the criteria at act 706. Oftentimes, sensors can be employed to determine user behavior in view of criteria. In a different embodiment, if criteria includes that a user stops at a store to earn a reward, a message can be sent to a clerk at the store requesting conformation that the user made an appropriate stop.

A check 708 can take place if the user met the criteria. If the user did not meet the criteria, then the check 708 can make a return loop and continuously check user status. While not shown in the methodology 700, a loop to check for user status can end under various circumstances. In one embodiment, a timing check can occur to determine if it is realistic that the user will meet the criteria or if time designated to complete the criteria is expired—if time passes, then the methodology 700 can end. In a different embodiment, a check can occur using a global positioning system to determine if the user has passed a store where they were supposed to stop based on reward criteria collected at action 702. If the user is determined to have passed the store, then the methodology 700 can end.

A check 710 can also take place to determine if a reward can be processed. It is possible that the reward cannot be immediately processed—for instance, the reward can be a bank transaction, but communication to the bank can be temporarily unavailable. Similar to check 708, a continuous loop can be made for when the reward can be processed. A success communication can be sent at action 712, oftentimes with checks 708 and 710 producing positive results. This can be to a third party associated with the reward or to a local unit that produces the reward (e.g., a printer outputting a coupon).

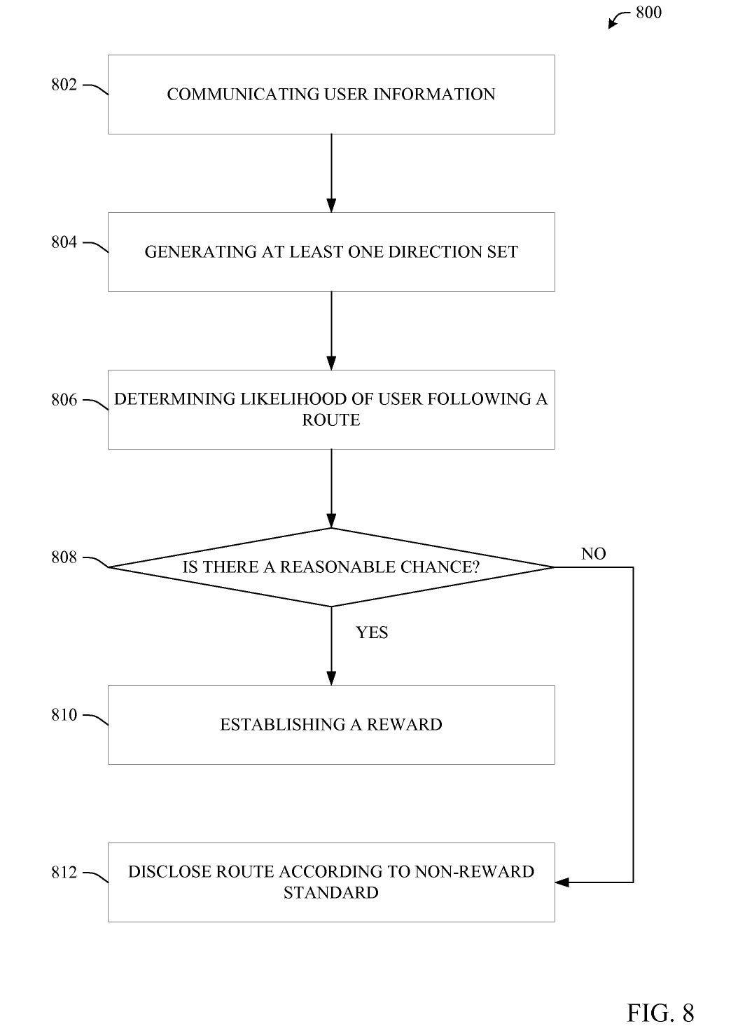

Now referring to FIG. 8, an example methodology 800 is disclosed for establishing a reward for use in conjunction with a travel route. User information can be communicated at event 802. This can include user preferences, previous user history, and the like. A direction set can be generated at act 804, which can be performed in a manner consistent with other portions of the subject specification.

A calculation can be made at action 806 on how likely a user is to follow a route. This can include probability statistics as well as outright asking a user if she would consider taking a route. A check 808 can take place to determine if there is a reasonable chance the user will follow the route. If the check 808 produces a positive outcome, then a reward can be established at action 810. If the check 808 produces a negative outcome, then the direction sent can be disclosed according to a non-reward standard at event 812.

For purposes of simplicity of explanation, methodologies that can be implemented in accordance with the disclosed subject matter were shown and described as a series of blocks. However, it is to be understood and appreciated that the claimed subject matter is not limited by the order of the blocks, as some blocks can occur in different orders and/or concurrently with other blocks from what is depicted and described herein. Moreover, not all illustrated blocks can be required to implement the methodologies described hereinafter. Additionally, it should be further appreciated that the methodologies disclosed throughout this specification are capable of being stored on an article of manufacture to facilitate transporting and transferring such methodologies to computers. The term article of manufacture, as used, is intended to encompass a computer program accessible from any computer-readable device, carrier, or media.

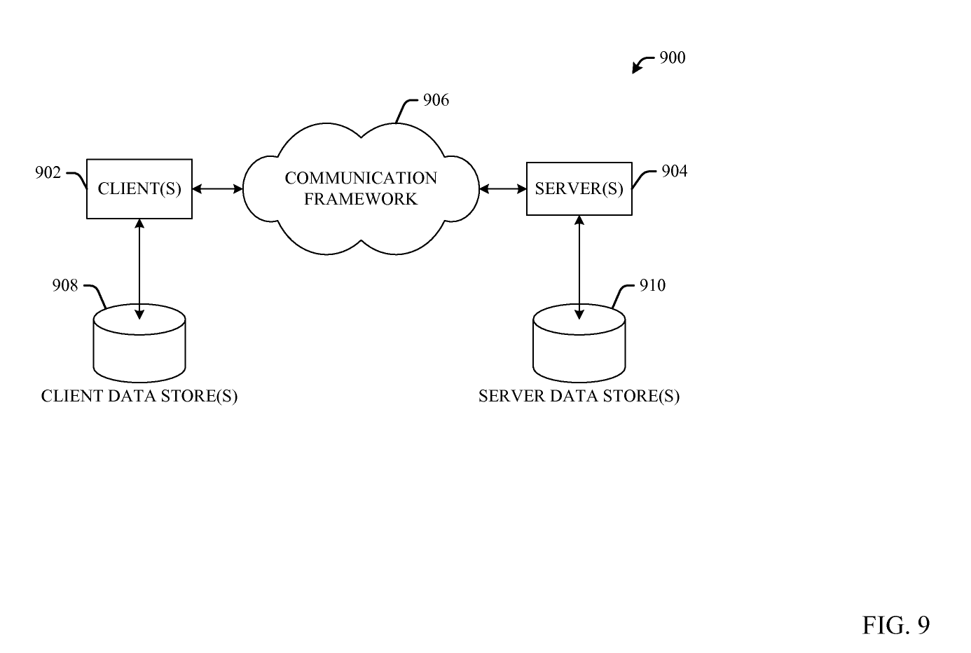

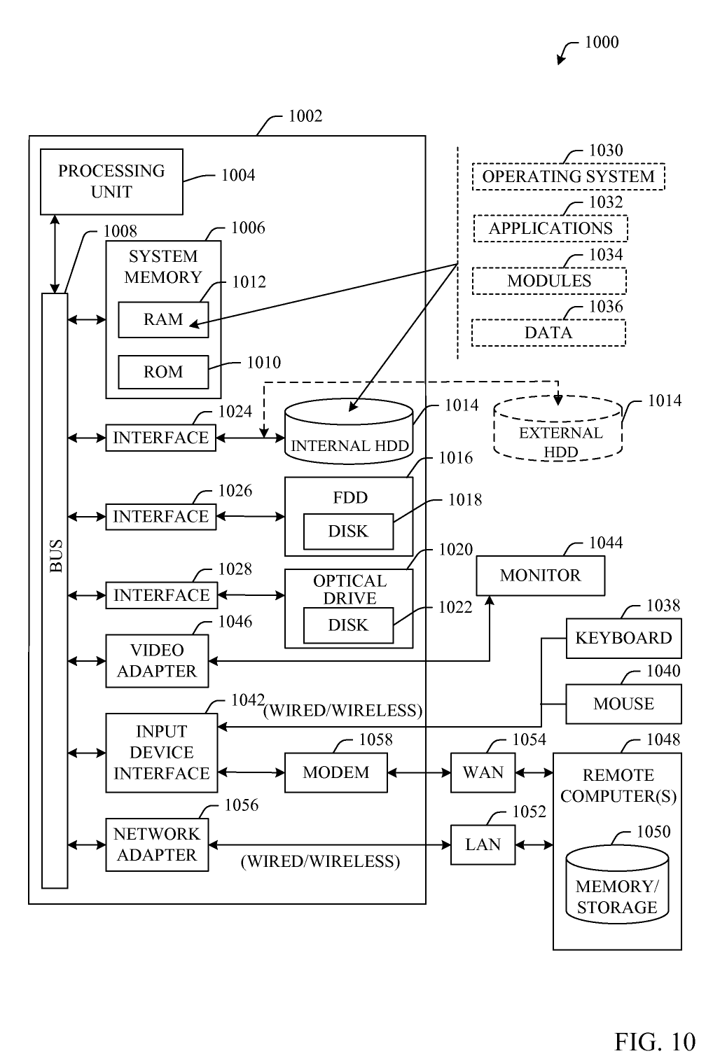

In order to provide a context for the various aspects of the disclosed subject matter, FIGS. 9 and 10 as well as the following discussion are intended to provide a brief, general description of a suitable environment in which the various aspects of the disclosed subject matter can be implemented. While the subject matter has been described above in the general context of computer-executable instructions of a program that runs on one or more computers, those skilled in the art will recognize that the subject matter described herein also can be implemented in combination with other program modules. Generally, program modules include routines, programs, components, data structures, etc. that perform particular tasks and/or implement particular abstract data types. Moreover, those skilled in the art will appreciate that the inventive methods can be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects can also be practiced in distributed computing environments where tasks are performed by remote processing devices that are linked through a communications network. However, some, if not all aspects of the claimed subject matter can be practiced on stand-alone computers. In a distributed computing environment, program modules can be located in both local and remote memory storage devices.

Referring now to FIG. 9, there is illustrated a schematic block diagram of a computing environment 900 in accordance with the subject specification. The system 900 includes one or more client(s) 902. The client(s) 902 can be hardware and/or software (e.g., threads, processes, computing devices). The client(s) 902 can house cookie(s) and/or associated contextual information by employing the specification, for example.

The system 900 also includes one or more server(s) 904. The server(s) 904 can also be hardware and/or software (e.g., threads, processes, computing devices). The servers 904 can house threads to perform transformations by employing the specification, for example. One possible communication between a client 902 and a server 904 can be in the form of a data packet adapted to be transmitted between two or more computer processes. The data packet can include a cookie and/or associated contextual information, for example. The system 900 includes a communication framework 906 (e.g., a global communication network such as the Internet) that can be employed to facilitate communications between the client(s) 902 and the server(s) 904.

Communications can be facilitated via a wired (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

Referring now to FIG. 10, there is illustrated a block diagram of a computer operable to execute the disclosed architecture. In order to provide additional context for various aspects of the subject specification, FIG. 10 and the following discussion are intended to provide a brief, general description of a suitable computing environment 1000 in which the various aspects of the specification can be implemented. While the specification has been described above in the general context of computer-executable instructions that can run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embody computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared and other wireless media. Combinations of the any of the above should also be included within the scope of computer-readable media.

With reference again to FIG. 10, the example environment 1000 for implementing various aspects of the specification includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors or proprietary specific configured processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 can also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the example operating environment, and further, that any such media can contain computer-executable instructions for performing the methods of the specification.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the specification can be implemented with various proprietary or commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) can include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 can operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 is connected to the local network 1052 through a wired and/or wireless communication network interface or adapter 1056. The adapter 1056 can facilitate wired or wireless communication to the LAN 1052, which can also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the input device interface 1042. In a networked environment, program modules depicted relative to the computer 1002, or portions thereof, can be stored in the remote memory/storage device 1050. It will be appreciated that the network connections shown are example and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

The aforementioned systems have been described with respect to interaction among several components. It should be appreciated that such systems and components can include those components or sub-components specified therein, some of the specified components or sub-components, and/or additional components. Sub-components can also be implemented as components communicatively coupled to other components rather than included within parent components. Additionally, it should be noted that one or more components could be combined into a single component providing aggregate functionality. The components could also interact with one or more other components not specifically described herein but known by those of skill in the art.

What has been described above includes examples of the subject specification. It is, of course, not possible to describe every conceivable combination of components or methodologies for purposes of describing the subject specification, but one of ordinary skill in the art can recognize that many further combinations and permutations of the subject specification are possible. Accordingly, the subject specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
an obtainment component that collects route information, reward data, contextual detail, or a combination thereof, and
an association component that links a reward to a route based upon at least a portion of the collection of the obtainment component.

2. The system of claim 1, further comprising an artificial intelligence component that performs at least one inference or at least one determination that concerns collection of information, collection of data, collection of a detail, reward linkage, or a combination thereof.

3. The system of claim 1, further comprising a disclosure component that presents the linked route to a user.

4. The system of claim 1, further comprising a transaction component that performs a financial operation that relates to collection of information, collection of data, collection of a detail, reward linkage, or a combination thereof.

5. The system of claim 4, the financial operation includes transfer of the linked reward based upon a user following at least a part of the route, the user following about all of the route, the user taking a designated action upon the route, or a combination thereof.

6. The system of claim 5, further comprising a check component that concludes if a user performed in a manner consistent with earning the reward, transfer of the linked reward occurs upon a positive conclusion.

7. The system of claim 6, further comprising an analysis component that evaluates material collected by the obtainment component, a result of the evaluation is used to choose the reward for linkage upon the route.

8. The system of claim 7, further comprising a summary component that maintains a profile of a user, profile information is collected by the obtainment component, evaluated by the analysis component, and used to choose a reward.

9. The system of claim 8, further comprising a modernization component that updates the profile of the user.

10. The system of claim 1, the association component links at least two rewards to a route based upon at least a portion of the collection of the obtainment component, a first reward is linked to a first user and a subsequent reward is linked to a subsequent user.

11. The system of claim 1, further comprising a selection component that chooses the reward for linkage upon the route.

12. A method, comprising:
correlating a reward with a route; and
establishing at least one criterion that a user follows to earn the reward, where the criterion includes at least one action taken upon the route.

13. The method of claim 12, further comprising constructing the route.

14. The method of claim 12, further comprising presenting the route and reward metadata to the user.

15. The method of claim 12, further comprising determining if the user has followed the criteria.

16. The method of claim 15, further comprising implementing the reward if it is determined that the user has followed the criteria.

17. The method of claim 12, further comprising determining a reward to correlate with the route, the reward is tailored to at least one user.

18. A system, comprising:
means for collecting route information, reward data, contextual detail, or a combination thereof;
means for analyzing at least a portion of the collected material;
means for selecting a reward, the selection is based upon a result of the analysis;
means for choosing at least one action for a user to follow upon a route in order to gain a reward, the choice is based upon a result of the analysis;
means for linking the selected reward with the route;
means for monitoring the user;
means for determining if the user followed the chosen action based upon a result of the monitoring; and
means for assigning the reward to the user.

19. The system of claim 18, further comprising means for disclosing the route to the user.

20. The system of claim 19, further comprising means for generating the route.
